(19) United States
(12) Patent Application Publication
(10) Pub. No.: US 2008/0250385 A1
(43) Pub. Date: Oct. 9, 2008

(54) AUTOMATING THE DEPLOYMENT OF APPLICATIONS

(76) Inventor: Elton R. Sanchez, San Jose, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/697,829

(22) Filed: Apr. 9, 2007

(51) Int. Cl. G06F 9/44

(52) U.S. Cl. 717/100

(57) ABSTRACT

Techniques are provided for automatically building and deploying applications from a developers' workstation to an MFP. An integrated development environment (IDE) executes a script that causes (a) source code files to be compiled into executable code, (b) the executable code to be packaged into an application, and (c) the application to be deployed to an MFP. The application may be deployed over a network directly to an MFP or to a server. If the application is deployed first to a server, then the MFP requests the application from the server.

### FIELD OF THE INVENTION

The present invention relates to deploying applications to multi-functional peripherals (MFPs).

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Developing application software is usually a long and tedious process. The process typically consists of multiple phases of writing, modifying, and compiling code, and testing the application software with the intention that the application software will execute properly in most (if not all) situations. However, current approaches for deploying applications to multi-functional peripherals (MFPs) require human actions and a significant amount of time.

One approach for deploying an application to an MFP is by having pre-existing Web application running on the MFP. Thus, a developer would open a Web browser, access the MFP using authentication information, and then upload the application by selecting a browse button, selecting the files of the application that are stored on the developer's computer, and instructing the MFP (via the Web browser) to upload to the selected files.

However, the above approaches require non-trivial manual interaction with the MFP which increases the probability of human error. Thus, there is a need to improve the deployment process to decrease the time for development and probability for error, and to improve the developer's experience.

### SUMMARY

Techniques for deploying applications to MFPs are provided. In an approach, an integrated development environment (IDE) executes a script that causes source files to be compiled into executable code, the executable code to be packaged into an application, the application to be signed for MFP deployment, and the application to be deployed to an MFP from a developer's workstation that executes the IDE. The MFP thereafter installs the application. The application may be deployed from the developer's workstation directly to the MFP over a network, or indirectly to a server, from which the MFP requests the application.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that illustrates a development, build, and software deployment process, according to an embodiment of the invention;

FIG. 2 is a block diagram that illustrates multiple mechanisms for deploying an application to an MFP, according to an embodiment of the invention; and

FIG. 3 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for automatically deploying an application from the development environment in which the application was generated to an MFP. An MFP is a device that provides multiple functionalities or services, such as a printing service, a scanning service, an archiving service, and a faxing service.

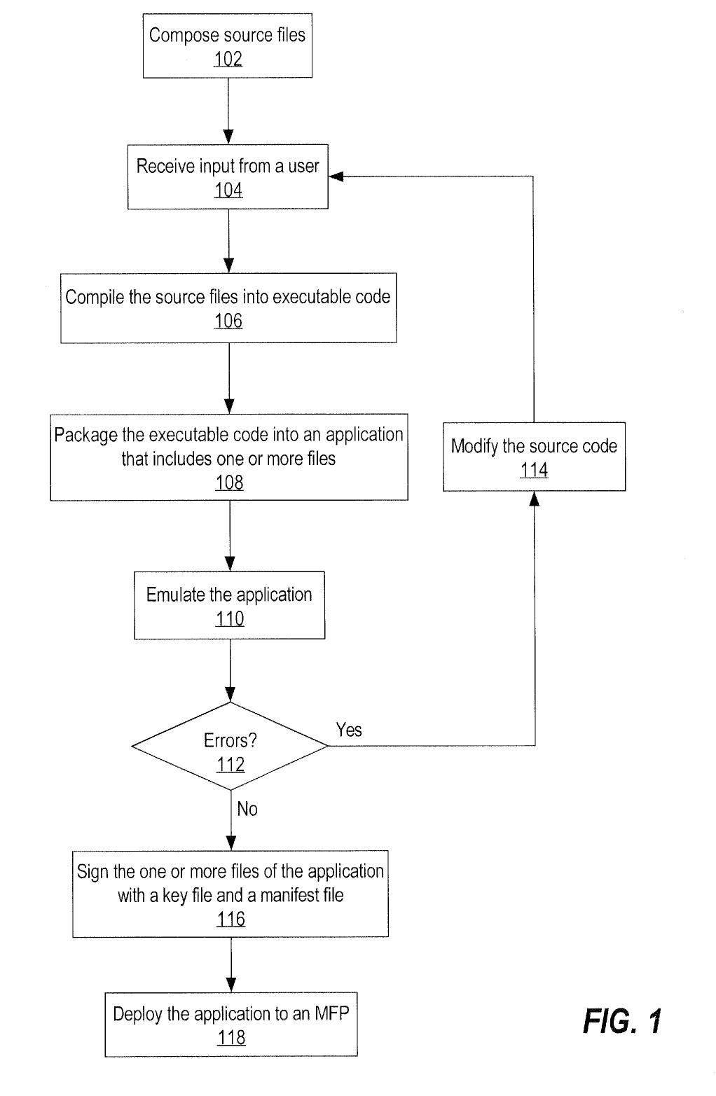

FIG. 1 is a flow diagram that illustrates a development, build, and software deployment process, according to embodiment of the invention. At step 102, one or more developers, using an IDE, compose source files for a particular project. Source files, as discussed herein, are not limited to any particular format or structure.

At step 104, the IDE receives input from a developer. The input may be received through a graphical user interface (GUI) button associated with the IDE or through a command line interface (CLI).

At step 106, as a result of the input, the IDE executes a script, which execution causes the source files of the project to be compiled into executable code. At step 108, execution of the script also causes the executable code to be packaged into an application that includes one or more Java archive (JAR) files. At step 110, the application is (optionally) emulated.

If the application is emulated, then, at step 112, it is determined whether there are any errors. If so, then, at step 114, the developer is given an opportunity to modify the source code. Steps 104-114 may be repeated until there are no errors or until the emulation step is skipped.

If it is determined that there are no (more) errors, then the process proceeds to step 116 where the files comprising the application are signed by a key file and a manifest file (if necessary) in order to permit deployment on an MFP. At step 118, the application is deployed to an MFP.

As used hereinafter, “deployment” refers to the distribution of software to one or more MFPs after the software has been properly packaged.

### Composition of an Application

According to an embodiment of the invention, an application comprises two types of files—one or more JAR files and a DALP file, which is described in more detail below. At least one JAR file forms the entry point to the application. This JAR file contains the actual application code and may be signed for authentication. There may be additional JAR files that contain open source libraries or other extended features that the application utilizes.

### Example Development Environment

According to an embodiment of the invention, an IDE executes a script that causes an application to be built and deployed. In an embodiment, the IDE includes the NetBeans CDC Mobility Pack, which enables programming of CDC devices with the NetBeans IDE.

CDC (or Connected Device Configuration) is a specification for devices that require more intensive uses than “simple” devices (e.g., a cell phone) would use. Many MFPs are considered CDC devices. The NetBeans CDC Mobility Pack is a component that executes on top of the NetBeans Platform.

The NetBeans Platform allows applications to be developed from a set of modular software components called “modules.” A module, in this context, includes (a) a JAR file that contains Java classes that are written to interact with the NetBeans Open APIs and (b) a manifest file that identifies the contents of the JAR file. Applications built on modules can be extended by adding new modules. Because modules can be developed independently, applications based on the NetBeans platform can be easily extended by third-party developers.

The NetBeans IDE is an open-source IDE written entirely in Java using the NetBeans Platform. NetBeans IDE supports development of all Java application types.

The IDE is not limited to the NetBeans IDE. Other example IDEs that may be used in embodiments of the invention include, but are not limited to, Eclipse (originally developed by IBM), JBuilder (developed by Borland), JDeveloper (developed by Oracle), and BlueJ (developed at the University of Kent and Deakin University).

Two types of example applications that may be developed for MFPs include a touch panel application (such as Xlet applications) and a web application (such as Servlet applications). A touch panel application is for users that interact directly with the MFP by using a touch panel display (and other features of the MFP) to select buttons and enter values in order to use one or more of the services provided by the MFP. If a web application is developed, then the MFP acts as a Web service in which a user may use a Web browser on the user's computer to access the MFP and utilize one or more of the MFP's services. For example, a user may use a Web browser to upload an electronic document to the MFP and request the MFP to print the electronic document.

### Device Emulator

In an embodiment, an IDE includes a device emulator for testing an application before the application is deployed. The device emulator is useful from the developer's point of view for several reasons. First, a developer may not have access to an MFP. Second, working at the same workstation in which the application is developed is more efficient for the developer. Additionally, it is not guaranteed that the MFP, for which a customer or user purchases the application, is the same MFP upon which the application is tested.

In an embodiment, execution of the script may cause the device emulator to automatically execute after the software build and packaging process completes. The device emulator may be configured to emulate multiple actions that a user might initiate on an MFP that executes the application. The device emulator may also be configured to compare the results of the actions with a set of expected results. If any actual result does not match a corresponding expected result, then the application is not deployed and the developer is prompted to further modify the source code to remove the apparent error.

### Automatic Deployment of Applications

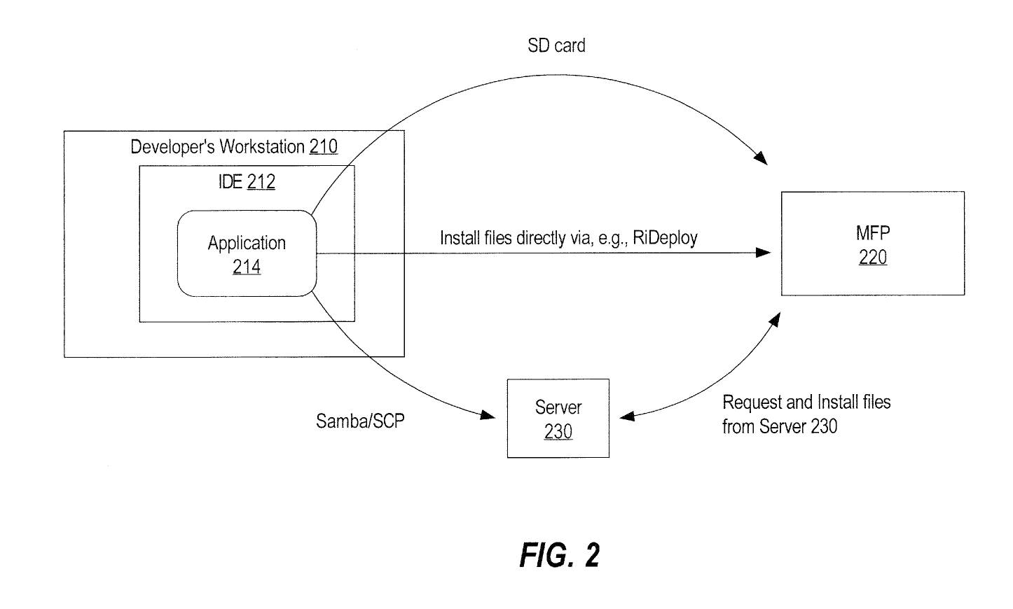

As described above, installing an application on an MFP requires several manual steps from a user or developer. In contrast, FIG. 2 is a block diagram that illustrates multiple mechanisms for automatically deploying an application 214 from a developer's workstation 210 to an MFP 220, according to an embodiment of the invention. Each mechanism is triggered by the execution of a script that is also used to build the application. For example, an IDE 212 executes the script to build application 214 by compiling the source files into executable code and packaging the executable code into application 214. Execution of the script also causes application 214 to be deployed to MFP 220. Application 214 may be deployed to MFP 220 in multiple ways.

First, application 214 may be sent from workstation 210 to a server 230 using, e.g., the Samba or SCP protocols, which are described in more detail below. An MFP model identifier, indicating the type of the intended MFP, may accompany application 214 as it is sent to server 230. MFP 220 then “pulls” application 214 from server 230. Server 230 may use HTTP to serve application 214 to MFP 220. Server 230 may be a Web server or may simple be any intermediate device that is capable of storing data and allowing processes on other devices to request and retrieve that data.

For example, MFP 220 may request a catalog of applications that have been saved to server 230. MFP 220, e.g., using a MFP model identifier, then requests application 214 (and any other applications) from server 230. MFP 220 may be configured to automatically and periodically request applications from server 230 that are intended to be installed on MFP 220.

Samba is an open source implementation of the SMB file sharing protocol that provides file and print services to SMB/CIFS clients. Samba allows a non-Windows server to communicate with the same networking protocol as Windows products. Samba was originally developed for UNIX but is now able to run on Linux, FreeBSD, and other UNIX variants. Samba is freely available under the GNU General Public License.

Secure Copy (or SCP) is a means of securely transferring computer files between a local and a remote host or between two remote hosts, using the Secure Shell (SSH) protocol. The term SCP can refer to one of two related things—the SCP protocol or the SCP program. The SCP protocol is similar to the BSD (Berkeley Software Distribution) rcp protocol. However, unlike rcp, data is encrypted during transfer, to avoid potential packet sniffers extracting usable information from the data packets. The SCP protocol itself does not provide authentication and security. Instead, the SCP protocol relies on the underlying protocol, SSH, to provide these features.

Second, application 214 may be sent directly from workstation 210 to MFP 220, e.g., via RiDeploy. RiDeploy is a web application that is developed by Ricoh. RiDeploy is a pre-existing web application that executes on MFP 220 and runs on the Java virtual machine. Thus, RiDeploy effectively waits for an application to be sent. When MFP 220 receives application 214, the one or more processes executing RiDeploy “wake up” and process application 214, e.g., by installing application 214 on MFP 220. Alternatively, web applications, other than RiDeploy, that perform similar functionality may be used for direct deployment from workstation 210 to MFP 220.

Third, as a result of executing the script, application 214 may be stored to a removable medium, such as an SD (Secure Digital) card, that is inserted into workstation 210 directly from workstation 210 to MFP 220

In an embodiment, execution of the script causes the files of application 214 to be signed with a key file and a manifest file as part of the deployment process. The key and manifest are used in conjunction with a password and alias (e.g., provided by Ricoh) to the developer to sign the application. Only then can the deployment successfully complete.

The manifest file typically contains three other parts: (a) a “fingerprint” of the main application JAR file (identified by an encrypted computed hash code), to indicate that, e.g., Ricoh has granted permission to install this JAR onto its machines (which prevents alteration of the contents of the main JAR file); (b) an expiration date (from which the manifest file will no longer sign applications); and (c) a set of rules that usually dictate one or more installation restrictions, such as no restrictions, or install the application only to specified machines by serial number.

The key file is used to sign the application and contains encryption information that is provided when signing the application with its valid manifest file.

In an embodiment, application 214 is first zipped (or converted to a compressed format) before IDE 212 deploys application 214. Compressing the files that comprise application 214 decreases network traffic and the time required to send application 214 to MFP 220.

Some MFPs (typically newer MFPs) are not required to restart (or reboot) in order to complete installation of a new application. However, other MFPs are required to restart. Therefore, in an embodiment, an application includes a boot script that a MFP executes when the MFP installs the application.

A boot script may be included in each deployment of an application, regardless of the target MFP. In such a case, depending on the target MFP, the target MFP may elect not to execute the boot script if the MFP “knows” that it is not necessary. Alternatively, the boot script is only included in deployments to MFPs that require a restart to complete installation.

### Ant Script

A script is a list of commands that can be executed without user interaction. An example of a script that an IDE executes in order to automate the build and deployment of applications is an Ant script. Ant is a Java-based build tool used to standardize and automate build and run environments for development.

Ant scripts are XML files that contain targets, which in turn contain tasks. An Ant target may depend on other targets, indicating that the other targets should be completed before the dependent Ant target begins.

Ant tasks are executable bits of code that handle the processing instructions for source code. Examples of Ant tasks include the “javac” task, which is used to compile the source code, and the “java” task, which is used to execute a class. There are three sources of possible Ant tasks: built-in tasks, tasks written by the developer of the application, and tasks written by third parties.

A predecessor of Ant is make. One of the primary aims of Ant is to solve make's portability problems. In a Makefile, the actions required to create a target are specified as shell commands which are specific to the current platform, usually a Unix shell. Ant solves this platform-specific problem by providing a large amount of built-in functionality which Ant can then guarantee will behave (nearly) identically on all platforms.

If SCP is used as the protocol to export the application from the development environment to a server, then a developer is not required to write an Ant target because Ant already has a predefined SCP task. In other words, an open-source implementation of SCP is included with Ant and can be used as any task, such as “javac” or “java”. However, even though Samba is open source, if Samba is used as the protocol to send applications to a server, then an Ant task for Samba might not be written or available. In that case, an Ant task must be written and Samba libraries should be consulted to create a proper Samba deploy target within the Ant script.

### Generation of DALP Files

A DALP file is an XML file that contains application metadata. Application metadata may include, but is not limited to, which JAR file is the entry point for the application, a designation of the required JAR files and MFP features, the developer(s) of the application, the name of the application, resolution of the application, and contact information for support.

Typically, a DALP file is written by a developer of the application. Thus, there is a risk of human error in composing the DALP file.

According to an embodiment of the invention, the IDE that executes the script that builds and deploys an application also provides input fields (e.g., via a GUI) to a developer of the application. The developer then inputs the appropriate values of the metadata information. After the values are received from the developer, the module generates the DALP file. In this way, the likelihood of human errors in generating the DALP file is significantly reduced.

### Implementation Mechanisms

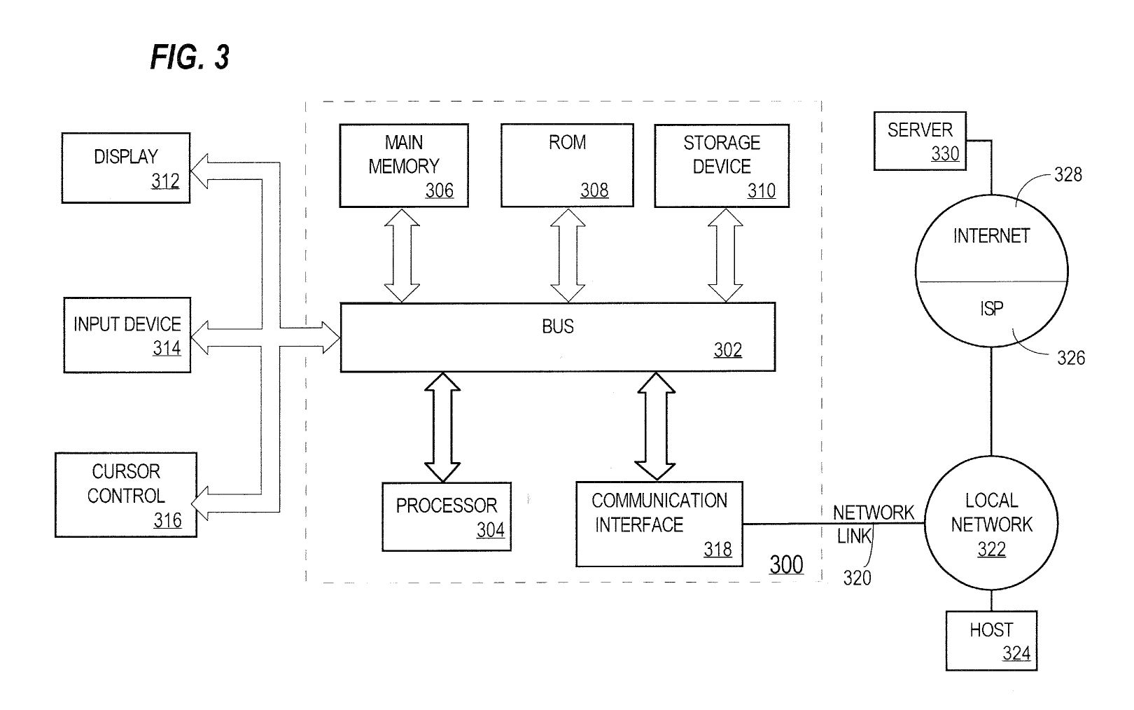

The approaches described herein may be implemented on any type of computing platform or architecture. FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for deploying applications to multi-functional peripherals (MFPs), the method comprising, in response to executing a script in an integrated development environment (IDE):
compiling a plurality of source files into executable code;
packaging the executable code into an application that comprises one or more Java archive (JAR) files; and
deploying the application to an MFP from a development workstation that executes the IDE, wherein:
the MFP comprises a plurality of service applications that each provides at least one service;
one of the plurality of service applications includes a print process for processing print data and causing a printed version of an electronic document reflected in the print data to be generated; and
the MFP installs the application.

2. The method of claim 1, wherein deploying the application includes one of:
deploying the application directly to the MFP over a network; or
deploying the application from the development workstation to a server, wherein the MFP requests the application from the server and the server sends the application to the MFP.

3. The method of claim 2, wherein:
deploying the application includes deploying the application from the development workstation to the server using the Samba protocol.

4. The method of claim 2, wherein:
deploying the application includes deploying the application from the development workstation to the server using the Secure Copy (SCP) protocol.

5. The method of claim 1, wherein:
deploying the application includes storing the application on a removable medium; and
the removable medium is inserted into the MFP.

6. The method of claim 1, wherein:
deploying the application includes signing the one or more JAR files with a key file and a manifest file.

7. The method of claim 1, further comprising:
before deploying the application, running an emulator, on the application, that emulates how one or more MFPs might execute the application.

8. The method of claim 1, further comprising:
displaying a GUI that allows a user to enter metadata information for the application;
receiving the metadata information from the user; and
based on the metadata information, generating a second file with a particular format;
wherein deploying the application includes deploying the second file from the development workstation to the MFP.

9. The method of claim 1, wherein:
deploying the application includes deploying a boot script; and
when the MFP installs the application, the MFP executes the boot script, which causes the MFP to reboot.

10. The method of claim 1, wherein the application also comprises one or more code libraries that support the application.

11. The method of claim 1, wherein the script is an Ant script.

12. A machine-readable medium carrying instructions for deploying applications to multi-functional peripherals (MFPs), which instructions, when executed by one or more processors, cause the one or more processors to perform, in response to executing a script in an integrated development environment (IDE):
compiling a plurality of source files into executable code;
packaging the executable code into an application that comprises one or more Java archive (JAR) files; and
deploying the application to an MFP from a development workstation that executes the IDE, wherein:
the MFP comprises a plurality of service applications that each provides at least one service;
one of the plurality of service applications includes a print process for processing print data and causing a printed version of an electronic document reflected in the print data to be generated; and
the MFP installs the application.

13. The machine-readable medium of claim 12, wherein deploying the application includes one of:
deploying the application directly to the MFP over a network; or
deploying the application from the development workstation to a server, wherein the MFP requests the application from the server and the server sends the application to the MFP.

14. The machine-readable medium of claim 13, wherein:
deploying the application includes deploying the application from the development workstation to the server using the Samba protocol.

15. The machine-readable medium of claim 13, wherein:
deploying the application includes deploying the application from the development workstation to the server using the Secure Copy (SCP) protocol.

16. The machine-readable medium of claim 12, wherein:
deploying the application includes storing the application on a removable medium; and
the removable medium is inserted into the MFP.

17. The machine-readable medium of claim 12, wherein:
deploying the application includes signing the one or more JAR files with a key file and a manifest file.

18. The machine-readable medium of claim 12, wherein the instructions, when executed by the one or more processors, further cause the one or more processors to perform:
before deploying the application, running an emulator, on the application, that emulates how one or more MFPs might execute the application.

19. The machine-readable medium of claim 12, wherein the instructions, when executed by the one or more processors, further cause the one or more processors to perform:
displaying a GUI that allows a user to enter metadata information for the application;
receiving the metadata information from the user; and
based on the metadata information, generating a second file with a particular format;
wherein deploying the application includes deploying the second file from the development workstation to the MFP.

20. The machine-readable medium of claim 12, wherein:
deploying the application includes deploying a boot script; and
when the MFP installs the application, the MFP executes the boot script, which causes the MFP to reboot.

21. The machine-readable medium of claim 12, wherein the application also comprises one or more code libraries that support the application.

22. The machine-readable medium of claim 12, wherein the script is an Ant script.
